(19) United States
(12) Patent Application Publication
(10) Pub. No.: US 2014/0354594 A1
(43) Pub. Date: Dec. 4, 2014

(54) TOUCH-SENSITIVE DATA CARRIER AND METHOD

(71) Applicant: Touchpac Holdings, LLC, New York, NY (US)

(72) Inventors: André Kreutzer, Mittweida (DE); Ronny Meissner, Dresden (DE)

(73) Assignee: Touchpac Holdings, LLC, New York, NY (US)

(21) Appl. No.: 14/365,779

(22) PCT Filed: Dec. 17, 2012
(86) PCT No.: PCT/EP2012/075803

§ 371 Date: Jun. 16, 2014

Related U.S. Application Data
(60) Provisional application No. 61/576,694, filed on Dec. 16, 2011.

(30) Foreign Application Priority Data
Dec. 16, 2011 (EP) 11193997.1
Jun. 27, 2012 (EP) 12174354.6

(51) Int. Cl. G06F 3/044; G06F 3/01

(52) U.S. Cl. CPC G06F 3/044; G06F 3/016
USPC 345/174

(57) ABSTRACT

The invention relates to a system for triggering at least one touch event on a resistive and/or capacitive input interface. The system comprises at least one layer of an electrically nonconductive medium, and contact surfaces are present on the medium as geometric shapes and/or lines, said medium being in contact with the input interface.

The invention relates to a system for triggering at least one touch event on a device having a capacitive and/or resistive input interface, wherein the system comprises at least one layer of an electrically nonconductive medium, the medium has touch areas present on it in the form of geometrical shapes and the medium is in contact with the input interface. In addition, the invention relates to a method for triggering an action and/or an event on an electrical appliance that has an input interface.

The prior art describes codes that are printed on printed media and can be read by an electrical appliance. One known code is the barcode, which is found in a wide variety of embodiments, e.g. on tags.

The barcodes are produced using conventional printing methods (such as offset printing, Flexo printing or intaglio printing) or individually as required (using laser printing methods, direct thermal printing methods, thermal transfer printing methods or ink jet printing methods, inter alia), depending on the application. There are also pseudo-stochastic (seemingly random) and irregular barcodes, such as finger lines, similarly pseudo-stochastic dot codes, which are almost uncopiable, and finally also purely random codes, which are uncopiable. There are both 1D barcode types with two bar widths and those with multiple bar widths. The barcode should have a certain minimum height, which is standardized in some cases. Furthermore, the width ratio between narrow and wide bars is also standardized. It is also necessary for a field to remain empty before and after the code—what is known as the quiet zone—in order to be able to decode the code correctly. It is open to any provider to define his own code. Thus, the diversity of already defined proprietary geometrical codes is great. Identification is usually possible without difficulty using all conceivable methods. The quality of a coding method can be found in the availability of suitable readers, the interoperability of use and the robustness of the code towards soiling and also, increasingly importantly, the security against forgery.

A further code printed on objects is the QR (quick response) code. The QR code comprises a square matrix of black and white dots that are a binary representation of the coded data. A special marking in three of four corners of the square prescribes the orientation. The data in the QR code are protected by an error-correcting code, as a result of which the loss of up to 30% of the code is tolerated and the code can still be read and decoded. Like the barcode, the QR code can be printed using all popular printing methods. However, care should be taken (as for the barcode) to ensure that the highest possible contrast is chosen, since otherwise the code cannot be captured completely. It is likewise possible for the code to be printed in color or else in multilayer. However, care must be taken to ensure that the code is printed as a halftone or as a line image and has uniform contrast.

The codes—both the QR code and the barcode—can be read using an appropriate reader. The prior art also describes methods that allow the code to be read using a mobile telephone. In this case, the code needs to be photographed by the appliance, with a special piece of software on the appliance decoding the code. Many mobile telephones and PDAs have an integrated camera and a piece of software that allows QR codes to be interpreted (also known as “mobile tagging”). By way of example, the code can be used to show a web address in coded form in periodicals or information sheets. The advantage of this method is that there is no need for the relatively laborious typing out. Besides URLs, QR codes may also contain telephone numbers, addresses, informative texts, premium SMSs, vCards, WLAN access data or geodata.

The readers or equipment described in the prior art are always suitable only for the individual application and cannot be used universally. Furthermore, they need to be connected to data-processing media via an interface so that the codes can be evaluated in the first place. The spread and acceptance of the readers is therefore relatively poor and entails additional cost for purchasing the readers.

A disadvantage of the known codes is that they are associated with system-typical handicaps, for example information can be copied as often as desired, takes up visual space on products or advertising media, is difficult to individualize in sufficiently good quality, and a direct line of sight is required between the code and the capture unit, with dirt, scratches, light conditions etc. complicating or completely preventing correct capture and reading of the information.

Photographing the codes using a mobile telephone also has numerous disadvantages. Not all mobile telephones that are commercially available have a camera. Furthermore, photographing is possible only under appropriate light conditions, with soiling on the printed medium or the camera also complicating or preventing the code from being read.

Accordingly, it was the object of the present invention to provide a system or method that allows a code to be read and does not have the disadvantages or defects of the prior art.

The object is achieved by the independent claims. Preferred embodiments can be found in the subclaims.

Therefore, a system for triggering at least one touch event on a device having a capacitive and/or resistive input interface is described, wherein the system comprises at least one layer of an electrically nonconductive medium, the medium has touch areas present on it in the form of geometrical shapes and the medium is in contact with the input interface, the medium being a material selected from the group comprising plastic, paper, card, glass, textiles or a combination of these. Within the meaning of the invention, an input interface denotes an input capability or an input appliance, particularly means for receiving and processing inputs. Within the meaning of the invention, input interfaces comprise not only appliances for input (e.g. a touchpad) but also appliances that are used as output and input appliances (e.g. a touchscreen). A touchscreen is additionally known to a person skilled in the art as an area sensor. The terms are used analogously within the meaning of the invention. The operator control elements may preferably be in the form of touch areas. In addition, it may be advantageous for the operator control elements to comprise real and software operator control elements.

Real operator control elements comprise traditional input instruments, such as pushbuttons, rocker switches, control wheels and slide controls. Real operator control elements are deemed an example of computer-based operator control elements in this case.

Software operator control elements are parts of graphical user interfaces and allow these to be operated. They are often described as dialogue modules and referred to as control elements or widgets. In this case, a widget is defined as an interaction element that is surrounded by a window that is characterized by its appearance (geometry) and its behavior.

Examples of advantages over real operator control elements are:
dynamic design
active and reactive
self-explanatory capability
large, complex functionality
optimized in terms of function

Examples of operator control elements within the GUI (Graphical User Interface) are buttons, text input fields or scrollbars.

The operator control elements should not be confused with the positioning means. The relationship between the two is that the position of the operator control elements is ascertained by tracking, for example from the data from the positioning means. In this case, tracking is an important part of augmented-reality or mixed-reality systems. In both systems, the physical environment is extended with virtual information or properties, and real objects are coupled to digital objects.

The action of bringing into contact sets up operative contact between the input interface and the medium by means of an input means. Within the meaning of the invention, operative contact describes bringing the medium into proximity of the input interface, so that an effect on the input interface is attained by means of the medium. The action of bringing into proximity denotes particularly a distance of between 0 cm and 2 cm between the medium and the input interface. Within the meaning of the invention, it may be preferred for the input interface to be of capacitive and/or resistive design, with the input interface possibly being part of an electronic appliance.

The geometrical shapes and/or lines can be put onto a printed medium, particularly a dielectric. Geometrical shapes or lines preferably comprise dots, bars, curves, areas and/or combinations of these. A person skilled in the art will recognize, on the basis of the disclosure of the present invention, that lines or shapes that are put on may also be corner points and/or solid areas defined by curves, for example rectangles, circles or similar figures. The local relationships between these shapes (orientation, number, alignment, distance and/or position) and/or the shape of the solid areas is/are preferably a piece of information that in turn triggers one or more touch events and preferably an action or an event on an input interface when touched with an input means.

Within the meaning of the invention, the shapes and/or lines, which may also be in the form of dots, are referred to particularly as guidance or operator control elements. In one preferred embodiment of the invention, a succession of the touch areas is present as guidance on the medium and/or the appliance (particularly the input interface). It is also preferred for a piece of information pertaining to the operator control of the touch areas to be present on the medium and, within the meaning of the invention, for information to denote particularly a succession of numerals and a description in the text that are used by a user as guidance for touching the medium. An input interface is preferably put behind this guidance (the illumination of thin media is particularly advantageous, allowing very simple handling and good positioning), with a user touching the guidance (i.e. the shapes and/or lines) with an input means and generating a touch event and triggering an event and/or an action on the input interface or the appliance that comprises the input interface. It is preferred for the medium to be brought into contact with the side of the electrical appliance that has the input interface.

The geometrical shapes and/or lines are preferably realized additively and/or subtractively on the medium. That is to say that it is preferred for the shapes and/or lines to be put onto the medium by means of additive methods. It may be preferred for the shapes and/or lines to be produced by means of subtractive methods. Alternatively, it is possible for said methods to be combined. A person skilled in the art can fill these methods with content and knows how they need to be applied to the system according to the invention. Furthermore, he knows that additive methods include printing methods, for example, and subtractive methods comprise punching, for example. In this case, it is possible to use printing methods that are known to a person skilled in the art, including relief printing methods, intaglio printing methods, flat screen printing methods, silk screen printing methods or electronic printing methods, in order to put the geometrical shapes and/or lines onto the medium or the layer.

It is also preferred for the electrically nonconductive medium additionally to have regions of electrically conductive regions present on it. These regions may likewise be present as geometrical shapes and/or lines on the medium. It may also be advantageous for a top layer to have been put onto the medium (or layers that are present thereon). The top layer may consist of the materials that are known to a person skilled in the art (particularly plastic or paper) and can be used particularly for protecting the medium or layers.

A user can follow the printed guidance, for example by touching at least one point or, in the case of multitouch appliances, simultaneously touching a plurality of points. The effect achieved by this is an input on the input interface, e.g. a touchscreen. A program or an application on the appliance carrying the input interface captures said input through the medium (particularly a dielectric) and triggers a touch event and preferably an event or an action or interprets the latter.

The medium can be assigned to or trigger an action by a data processing system, preferably in conjunction with the input interface. Within the meaning of the invention, an event denotes particularly what is triggered by an action and hence a state change, preferably within applications. These events may be user inputs or system events, for example. The system is preferably used to trigger an action and/or an event on an electrical appliance that has an input interface. The information on the medium is preferably in the form of code. The input interface interprets the code that is present on the medium and preferably triggers an action within a web app or a program.

It is also possible for web apps or programs to be triggered by means of the medium on the input interface. That is to say that the medium, or an input through the medium, preferably triggers a program or a web app on the electrical appliance. Within the meaning of the invention, inputs on an input interface are particularly referred to as a touch event or touch input. The system is preferably used to input a touch event on an input interface.

It was totally surprising that the preferred system can be used to produce relatively high data densities on single touch appliances by virtue of inputs being effected in a manner staggered over time. Within the meaning of the invention, single touch appliances describe particularly input interfaces that can process only single touch and not multitouch.

In addition, the system can be used for dynamic movements for inputting a touch event, which result from the input using the finger or suitable input stylus and thereby achieve a specific data input. By way of example, a newspaper advert can be printed with normal ink, wherein geometrical shapes and/or lines (i.e. guidance) that trigger a touch event and an action and/or event on an input interface when the latter is brought into contact with the printed medium and a user touches the shapes and/or lines are printed in the advert. The layout of the newspaper adverts is not disrupted by the integration of the guidance. This is a considerable advantage over the prior art, since known codes would crucially alter the appearance of an advert.

It may be preferred for a positioning means to be present on or in the medium, which positioning means allows the positioning of the medium on the input interface. In this case, a frame (complete or partial frame) or reference point may be preferred. The positioning means can be used to produce optimum positioning for the medium on the input interface, so that absolutely error-free use is allowed. It may be advantageous for the input interface and/or the medium to have one or more positioning means.

The positioning means may be a tactile, haptic, visual, audible, electrically conductive or mechanical means. By way of example, the medium may thus have one edge as positioning means that puts the medium into a particular position on the input interface. The edge as positioning means advantageously abuts the electrical appliance. It may also be preferred for the input interface to visually display a position or field as positioning means or operator control element, for example, onto which the medium needs to be laid or put. This allows the use of the medium to be substantially simplified for a user.

In one preferred embodiment, the medium comprises haptic, visual or tactile operator control elements selected from the group comprising
a. Change in a surface structure of the material of the medium.
b. Relief and/or embossment on the medium
c. Different materials
d. Printed regions
e. Cutouts
f. Punchings from the medium and/or
g. Perforations.

However, it may also be advantageous if the medium and/or the input interface have operator control elements. The operator control elements may particularly be aligned to the positioning means, so that dynamic alignment advantageously takes place. In addition, it may be preferred for static operator control elements to be present that are present particularly in printed form on the medium or are displayed at a previously defined position on the input interface. The operator control elements, positioning means and/or the touch areas preferably have at least one layer of an electrically conductive material.

In addition, it may be advantageous to incorporate a feedback system on the input interface, which system uses visual, haptic, tactile and/or auditive means to report correct/incorrect positioning and/or an input of a touch event. This makes it possible to easily and quickly convey to the user whether an input has been made, so that a correct input is assured.

It is preferred for the medium to be a material selected from the group comprising plastic, paper, card, glass, textiles or a combination of these. In particular, the medium may also be made from card, wood-based material, composite material, ceramic and/or leather. The medium is particularly an electrically nonconductive substance that is preferably flexible and has a low weight. Preferably, transparent media are used. Preferred plastics include, in particular, PVC, PET, PC, CA, PETX, PP, OPP, PE and synthetic papers.

In one preferred embodiment of the invention, the input interface is an input interface that is based on a capacitive and/or resistive technique. Within the meaning of the invention, the input interface also comprises touchscreens or sensor screens and, in the case of a combined input and output interface, is particularly a touch-sensitive layer that has been put onto, into or behind a screen and that reacts to contact from the user with his finger or a pointing stylus that is suitable depending on the technology used. The input interface is a means with direct action, that is to say that the input takes place directly on the space displayed, rather than beside the display, as would be the case with a mouse or keyboard, for example. Therefore, touchscreens afford extremely intuitive operator control, since the screen is simultaneously used as a user interface and it is not necessary to choose the indirect route via external input appliances. The electrical appliance that has the input interface is preferably selected from the group comprising touchscreens, touchpads, smartphones, mobile phones, displays, tablet PCs, tablet notebooks, touchpad appliances, graphics tablets, televisions, PDAs, MP3 players, trackpads and capacitive input interfaces.

The input interface and the touchscreens are based on different principles of action, with resistive and capacitive technologies being the most widespread. By way of example, resistive touchscreens consist of two opposite, transparent, conductive ITO layers (indium tin oxide) that are separated from one another by numerous insulated spacers, known as “spacer dots”. The inner ITO layer is situated on a solid glass screen, for example, and the outer layer is protected by a flexible, scratch-resistant plastic film.

A controller is used to alternately apply a voltage to the conductive layers, as a result of which a voltage gradient in the X direction is produced on the inner layer, for example, and a voltage gradient in Y direction is produced on the outer layer, for example. As soon as the screen is touched, the upper layer is pushed onto the one situated beneath, and hence electrical contact is made and the respective zero-voltage layer forms a voltage divider on the live layer, the magnitude of said voltage divider being obtained from the position of the touch point on the live layer. From this, it is possible to calculate the corresponding X and Y coordinates of the touch point.

On the other hand, in the case of capacitive technology, a respective multiplicity of conductor tracks made of conductive material that run parallel to one another are applied to two physically separate planes, such as the top and bottom of a film or of a glass substrate. Capacitances develop at the crossing points of the horizontally running conductor tracks in one plane and the vertically running conductor tracks in the other plane.

The electrical actuation of the conductor tracks in one plane (transmission lines) produces a measurable signal on the conductor tracks in the second plane (reception lines). A touch on the system by a user, e.g. using his finger, influences the capacitive coupling between transmission and reception lines as a result of which the signal from the reception line is altered. The resultant signal changes are subsequently evaluated and the respective transmission and reception lines are used to determine the coordinates of the touch. Besides single touch, multitouch recognitions are also possible, which means that multiple fingers or input elements can trigger a touch event. The purpose of an input interface, as described in the prior art, is particularly the detection of fingers and the position thereof on the surface of the input interface.

It was now totally surprising that this effect can be obtained with the system according to the invention, even though an electrically nonconductive medium (at least one layer) is arranged between the input interface and the input means (such as one or more fingers). Within the meaning of the invention, this can also be referred to as a layer structure that comprises the input interface, the medium and an input means. That is to say that the input interface has an electrically nonconductive medium situated on it. The prior art tells a person skilled in the art that, by way of example, input on capacitive touchscreens requires the use of electrically conductive means. Accordingly, the invention can be referred to as the departure from what is usual, since a touch event is triggered on a capacitive input interface by means of an electrically nonconductive medium. In addition, a system is provided that triggers a touch event on a capacitive and/or resistive input interface. The system can therefore be used universally.

The medium can easily be brought into contact with the input interface by placing it onto the latter or putting it against the latter. It can also be mounted thereon, in particular reversibly, using the mounting means that are known to a person skilled in the art. However, it is preferred for the medium to be in contact with the input interface only briefly, advantageously only until a touch event on the input interface or an action and/or an event is triggered.

In a further preferred embodiment of the invention, the electrically nonconductive medium comprises electrically conductive regions, in particular the electrically nonconductive medium additionally has regions of electrically conductive regions present on it. Although the medium that holds the geometrical shapes and/or lines is preferably electrically nonconductive, it can contain regions that are in electrically conductive, in particular semiconductive, form. The electrically conductive regions may be physically separate from the electrically nonconductive regions. An example that may be cited here is a page of a magazine, which admittedly basically consists of paper, i.e. an electrically nonconductive material, but can have at least regions printed with an electrically conductive ink or layer. By way of example, the electrically conductive regions may be patterned and designed such that they trigger a touch event on an input interface in combination with the geometrical shapes and/or lines on the electrically nonconductive layer. The geometrical shapes and/or lines have been put onto electrically nonconductive regions of the medium, however.

It may also be preferred for a plurality of layers of an electrically nonconductive medium to be in contact with the input interface in combination, particularly next to one another and/or above one another. The medium can be folded or creased, for example, so that different regions of the electrically nonconductive medium are brought into physical proximity, as a result of which a user, after the medium is brought into contact with an input interface, needs to interact with both regions in order for a touch event to be triggered on the input interface. It was totally surprising that it is possible to achieve an input on an input interface even in the case of laminated media (e.g. cardboard standups at the point of sale) in which a plurality of layers are present next to one another.

The invention also relates to a method for triggering at least one touch event on an input interface comprising the following steps:
a. at least one layer of an electrically nonconductive medium is brought into contact with a touch-sensitive area of an input interface,
b. at least one geometrical shape that is present on the layer is touched using an electrically conductive or nonconductive means, and
c. at least one touch event is triggered on the input interface.

The preferred method can be used to trigger particularly actions and/or events on an electrical appliance that has the input interface.

In one preferred embodiment, the method for triggering at least one touch event on an input interface comprises the following steps:
a. A layer of the medium in the system described above is brought into contact with a touch-sensitive area of an input interface,
b. at least one touch event is triggered on the input interface by means of the conductive regions,
c. the conductive regions of the medium are recognized or identified,
d. the operator control elements are aligned on the touch-sensitive area of the input interface. The operator control elements can advantageously be presented anywhere on the input interface; preferably, they are aligned with the medium and/or the electrically conductive areas.
e. the functionalities of the operator control elements are activated.
f. at least one further touch event is triggered by a user on the touch-sensitive area of the input interface.

A layer of an electrically nonconductive medium holds geometrical shapes or lines. The layer or the medium is brought into contact with a touch-sensitive area of an input interface, particularly of an input appliance. The input appliance can also be referred to as touchscreen and is preferably part of an electrical appliance. At least one shape or line on the layer, or the medium, is contacted or touched by an electrically conductive or nonconductive means. For the input, namely the contacting of a shape or line on the layer, an input means is preferably used that is capable, alone or through use, of bringing about an influence on the reception line of the reception area or reception electrode of the input interface and hence triggers at least one touch event on the input interface. Such an input means is already known to a person skilled in the art from US 2010/0060608 A1. An input means within the meaning of the invention is particularly a finger or a stylus.

An essential advantage of the system and method according to the invention is that it can be implemented in already existing printing techniques. By way of example, it can be incorporated into the printing of daily newspapers or periodicals without the need to adjust the printing technique.

The effect achieved by touching the shapes and/or lines with an input means using the electrically nonconductive layer is an interaction with the input interface, as a result of which, in turn, a touch event is triggered on the input interface. The method can preferably be used to trigger an action and/or an event on an electrical appliance that has the input interface or on the input interface itself.

It is preferred for the layer of the electrically nonconductive medium to be touched statically, dynamically, once, repeatedly, simultaneously and/or in a manner staggered over time. That is to say that the touch may be executed as a dynamic movement, e.g. swiping, tapping, rotating, dragging, pushing, or as a static touch. A user can touch the shapes and/or lines that have been put onto the layer in particular once, or repeatedly, and it may also be preferred for the user to have to touch a plurality of shapes, e.g. dots, once or repeatedly or follow a line on the medium with a finger or with an input means, with the contact persisting over a relatively long period and the position of the finger or of the input means on the layer being altered. In addition, it is preferred for the touch to be effected simultaneously and/or in a manner staggered over time. The input can therefore be in the form of a single touch, multitouch or in the form of a gesture. A person skilled in the art is familiar with these terms and can incorporate them under the technical teaching of the invention. In this regard, it may also be preferred if the touch areas to be touched and an order for the touch are indicated by the input interface and/or the medium. For this, the order can be displayed as a succession of numbers on the medium, for example, so that the user has to touch the touch areas in succession, for example.

The invention also relates to the use of the system described above for triggering an action and/or an event on an electrical appliance that has an input interface. The embodiments and advantages of the system can be applied to the use analogously. In one preferred embodiment, the medium and/or appliance indicates the regions to be touched and the order, type and gesture of the touch.

The invention will be explained by way of example below with reference to figures, but without being limited thereto. In the figures:

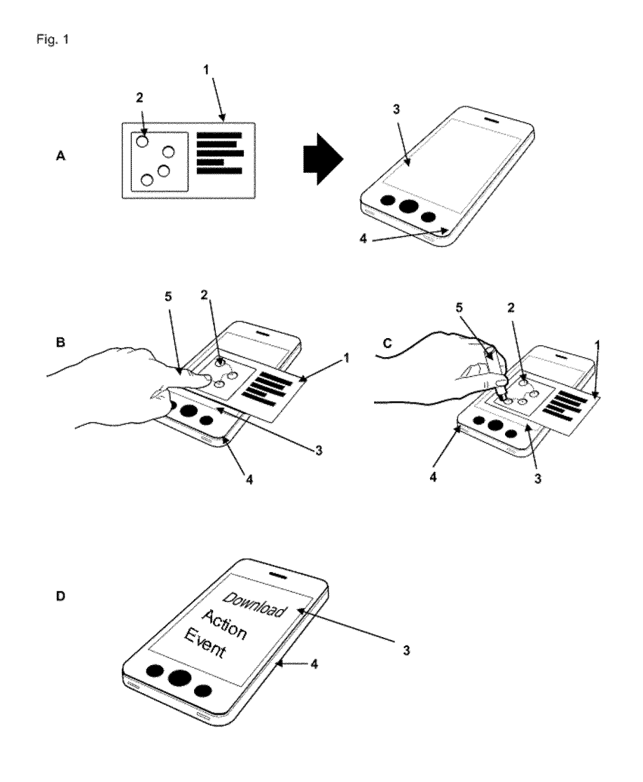

FIGS. 1A-D show a preferred method for triggering at least one touch event on an input interface,

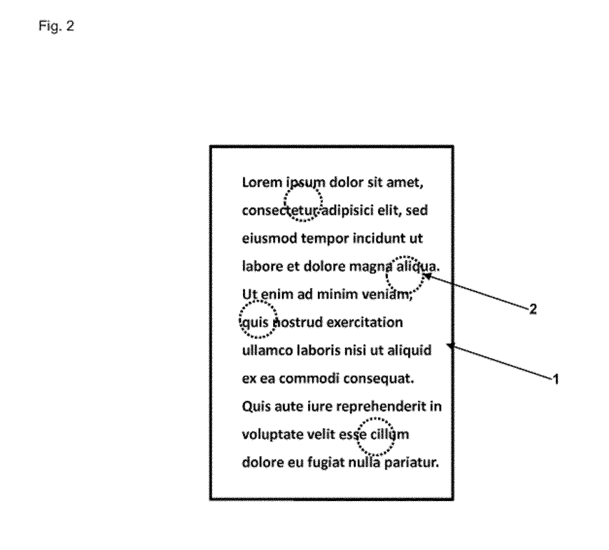

FIG. 2-FIG. 6 show a preferred embodiment of the touch areas,

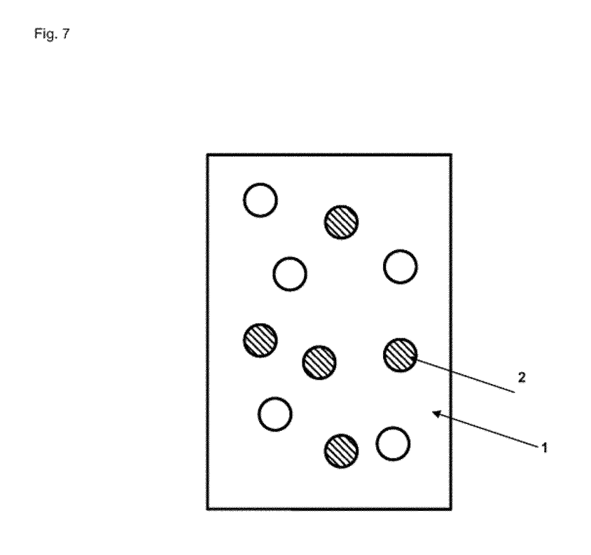

FIG. 7 shows touch areas produced by a subtractive method,

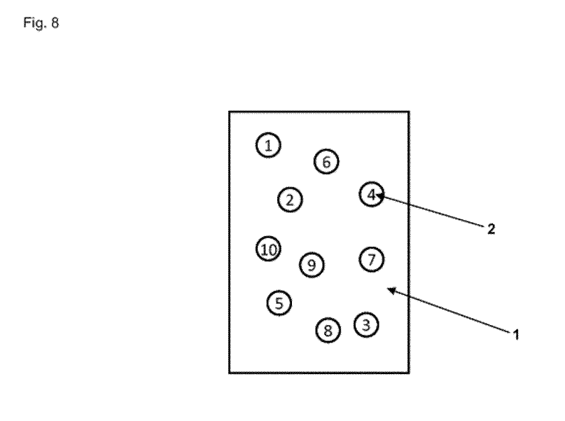

FIG. 8 shows numbering of subtractive and additive touch areas,

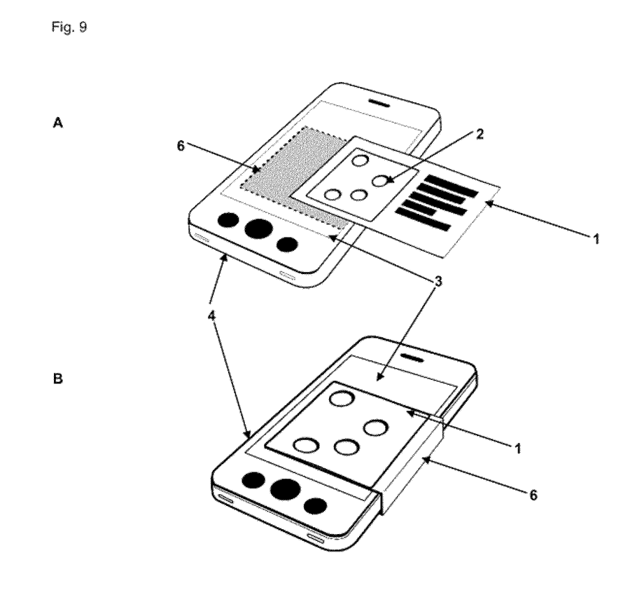

FIGS. 9A and B show positioning means on the input interface or the medium,

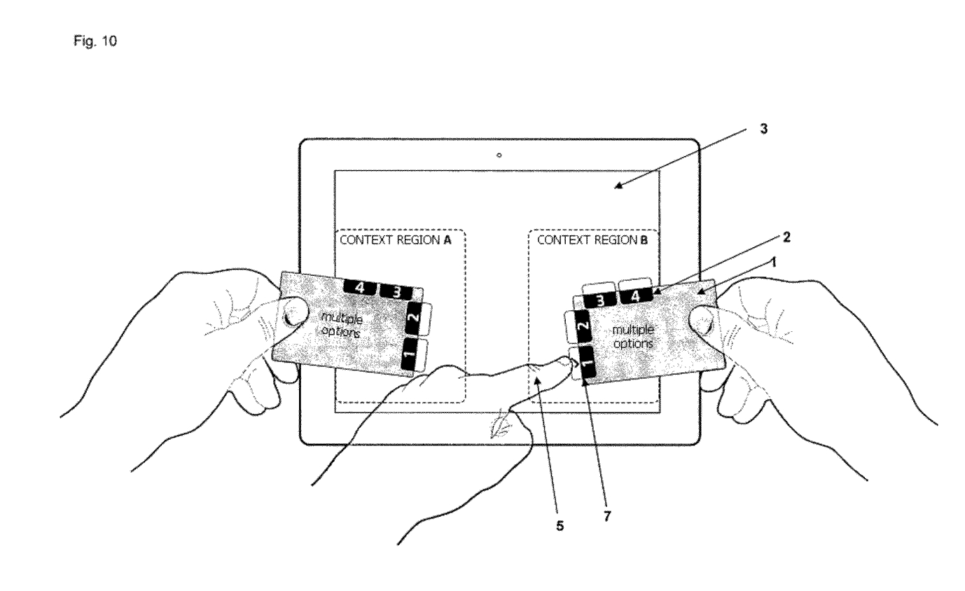

FIG. 10 shows context-dependent input,

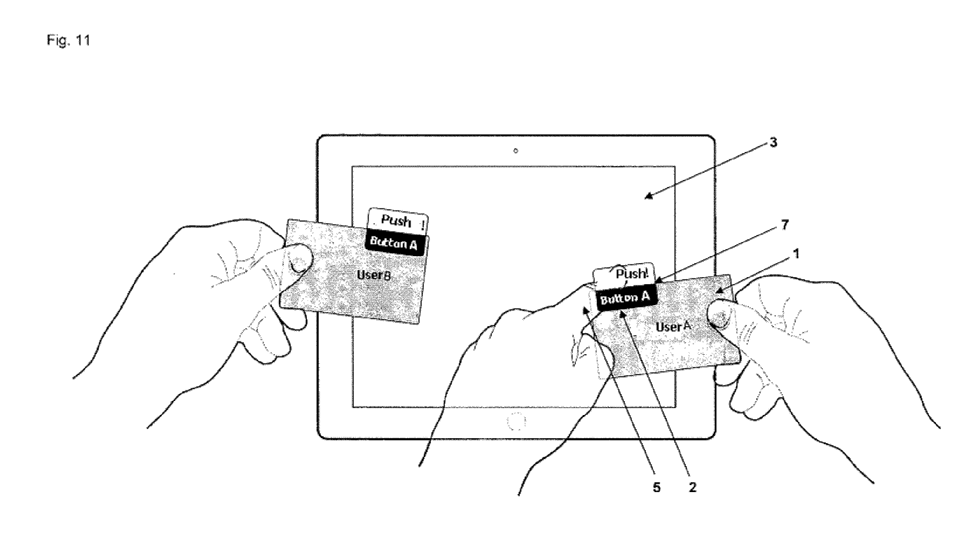

FIGS. 11-13 show embodiments of operator control elements on the medium,

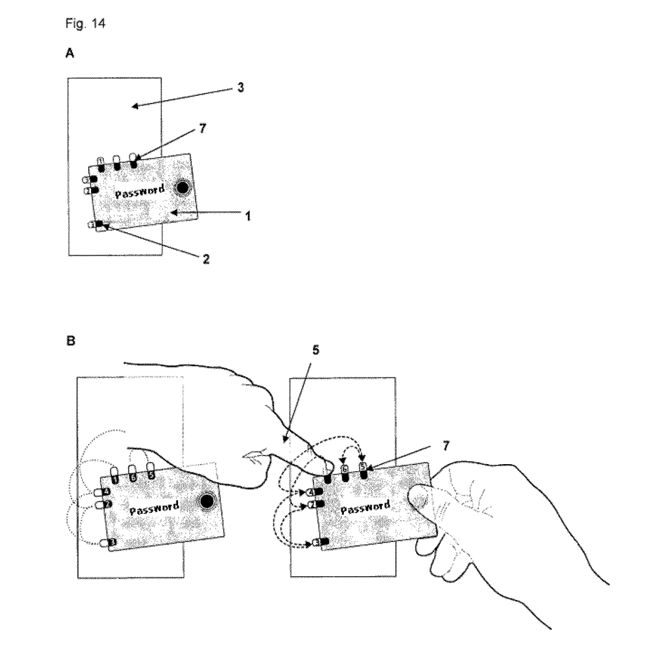

FIGS. 14A-B show dynamic input on the medium,

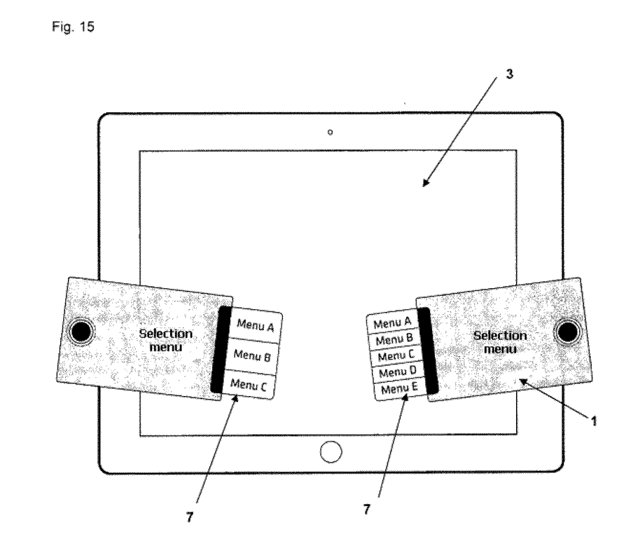

FIG. 15 shows a further variant embodiment of a dynamic input on the medium,

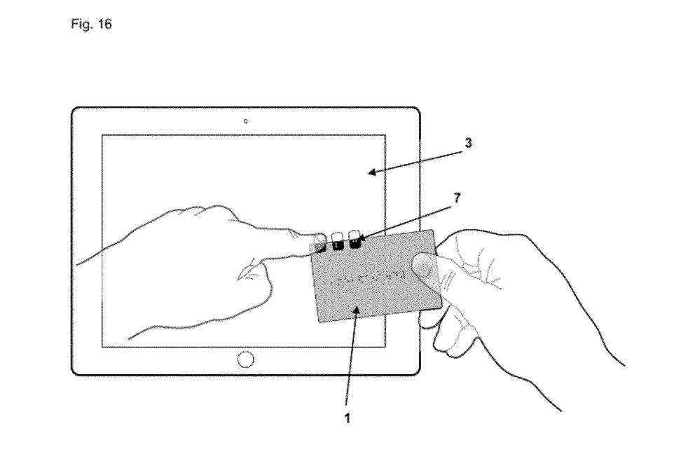

FIG. 16 shows a medium as an operator control aid.

FIGS. 1A-D show a preferred method for triggering at least one touch event on an input interface. A medium 1, which may be a paper page in a periodical, for example, holds not only a text but also a region with touch areas 2. The touch areas 2 may preferably be in the form of dots and/or lines. The medium 1 can be brought into contact with an input interface 3 (FIG. 1A), the input interface 3 being able to be a touchscreen, for example, and being part of an electrical appliance 4, for example a smartphone. The input interface 3 is preferably brought beneath (or behind) the medium 1, so that the touch areas 2 preferably rest on the input interface 3 or are in contact therewith (FIG. 1B). The touch areas 2 are preferably present as guidance for use on the medium 1. A user can touch the touch areas 2 on the medium 1 with an input means (e.g. a finger) 5 and thereby trigger one or more touch events on the input interface 3. An input means 5 within the meaning of the invention is particularly a finger (FIG. 1B) or a stylus (FIG. 1C). However, it is possible to use any input means 5 that is capable, alone or through use, of bringing about an influence on the reception line, the reception area or reception electrode of the input interface and hence triggers at least one touch event on the input interface. The touch events in turn can achieve an event and/or an action, e.g. a download, on the input interface 3 or the electrical appliance 4 (FIG. 1D).

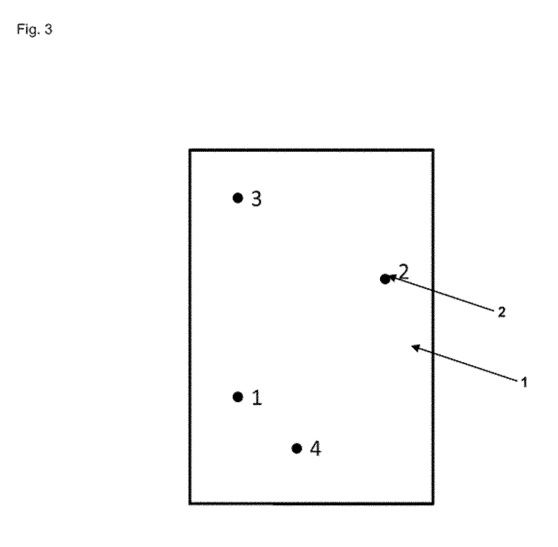

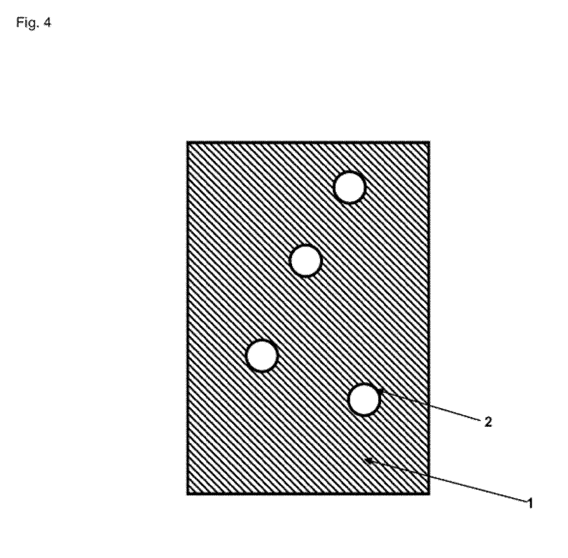

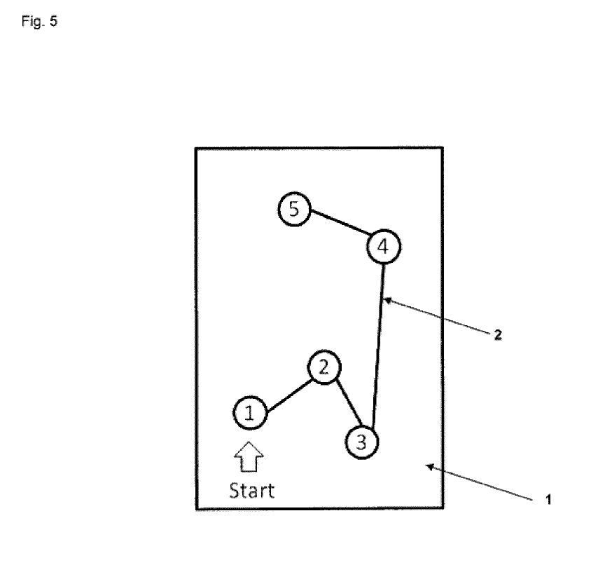

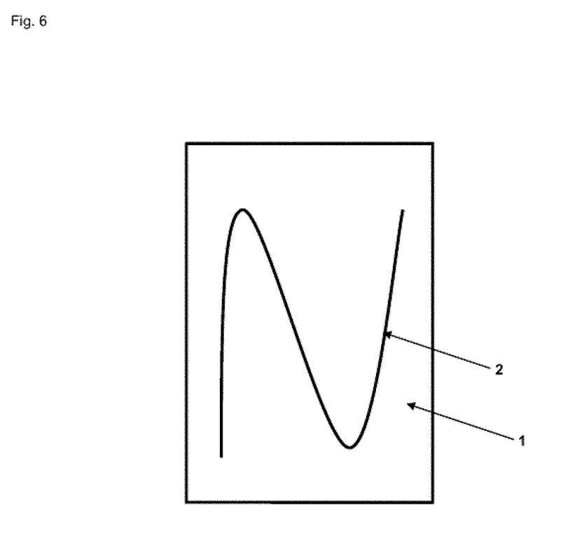

FIG. 2 to FIG. 6 show preferred embodiments of the touch areas. The touch areas 2 are preferably present on the medium 1, the medium 1 being an electrically nonconductive medium 1, particularly paper. Touch areas 1 can be put onto the medium 1 by means of additive methods. Preferably, the touch areas 2 are printed onto the medium 1, with the touch areas 2 being incorporated into a text on the medium 1 such that they do not disadvantageously influence the layout or legibility of the text. In order to simplify the operator control of the medium 1 by a user, the touch areas 2 may be present as guidance on the medium 1. By way of example, it may be preferred if the touch areas 2 are provided with numbers that tell a user the order in which the individual touch areas 2 need to be touched when the medium 1 is resting on an input interface (FIG. 3). It may also be advantageous to the operator control for the touch areas 2 to be emphasized on the medium 1 by color or layout (FIG. 4). The guidance or user guidance for a user may be in a form such that only individual touch areas 2, which may be in the form of dots and/or lines, need to be touched. In addition, it may be advantageous for a plurality of touch areas 2 to be touched in succession or simultaneously. In this case, the touch areas 2 may be in a form such that a user needs to touch a succession of touch areas 2 in the form of dots in succession without breaking the contact between the input means and the input interface (FIG. 5 and FIG. 6). As a result, the user can follow lines on the medium 1 or the input interface, as a result of which a simple pattern is provided for “tracing” with an input means. These patterns may also be company logos, images or other presentations. The guidance for operator control of the touch areas 2 can be presented in shapes, color or arrangement. It may also be preferred for the touch areas 2 to be generated by subtractive methods. In this case, the touch areas 2 can be punched from the medium, for example or removed by other subtractive methods (FIG. 7). Accordingly, the touch areas 2 may also be holes in the medium that are touched by a user, and in this way a touch event is triggered on an input interface. In addition, it may be advantageous to combine subtractive and additive methods in order to produce touch areas 2 on a medium (FIG. 7). The punched touch areas 2 can likewise be provided with printed numbers, as a result of which the user needs to touch the touch areas 2 in a defined order in order to generate a touch event (FIG. 8).

FIGS. 9A and 9B show positioning means on the input means or the input interface. In order to make it easier for a user to position the medium 1 on the input interface 3 or to position the input interface 3 underneath the medium 1, the input interface 3 and/or the medium may have one or more positioning means 6. The positioning means 6 may be a tactile, haptic, visual, audible or mechanical means. By way of example, the medium 1 may thus have one edge as a positioning means 6 that is used to bring the medium 1 into a particular position on the input interface 3. The edge as positioning means 6 advantageously abuts the electrical appliance 4. It may also be preferred for a position or field, for example, to be visually displayed on the input appliance 3, onto which positional field the medium 1 needs to be laid or put. This can considerably simplify the use of the medium 1 for a user. A positioning means within the meaning of the invention defines particularly information for producing a reference, consisting of translation (position), rotation, speed, acceleration and jolt (as the result of a tracking calculation). Tracking denotes particularly tracking of captured actual movements for mapping on technical systems.

FIG. 10 shows context-dependent input. In respect of the context, the interaction with media is preferably divided into context-related and context-free functions. As shown in the figure, functions can be altered on the basis of the position of rest. By contrast, functions can vary as a result of different media. In this way, it would be possible to associate different users with interactions. Two context regions are shown on an input interface 1 (e.g. a multitouch appliance) with an identical medium design. Depending on the position of rest of the operator control element 7, different options are activated and displayed on the input interface. Within the context region A, options one and two are activated (left). By contrast, options one, two, three and four are available in the context region B (right). In this regard, it was totally surprising that, in a preferred embodiment, in which the medium comprises an electrically conductive area or layer, the latter can be used for orienting or positioning the operator control elements. That is to say that by bringing the medium into contact with an input interface it is possible for the operator control elements to be optimally matched to the position of the medium on the input interface and displayed for a user on the input interface.

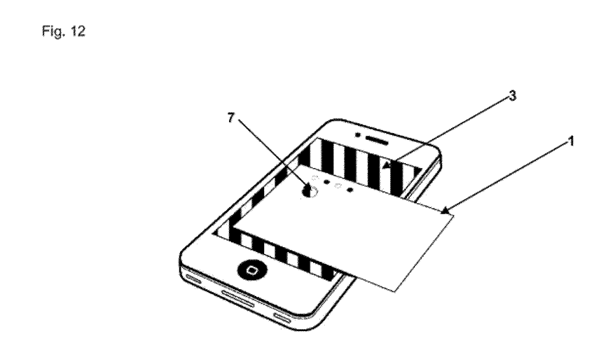

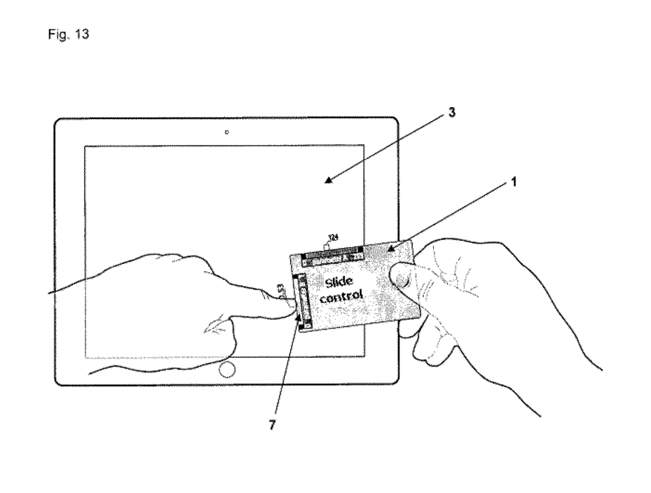

FIGS. 11-13 show embodiments of the operator control element on the medium. In contrast to NUI or GUI operator control elements, the operator control elements according to the invention can better address the haptic and tactile perception. In this connection, the following properties may be preferred in addition to visual forms: fine changes in the surface structure of the medium surface, or of the operator control element surface (smooth or rough); relief or embossment on the medium, use of different materials; cutouts or punched-out regions (see FIG. 12). These properties of the operator control elements 7 make it possible, by way of example, to implement two media 1 having the same operator control elements 7, which bring about different actions on the input interface 3, however. These properties of the operator control elements can extend the medium with tactile and haptic components. By way of example, it is preferred for interaction regions to be restricted or limited by means of relief structures. Following on from this, it would be possible for permitted interaction regions to be signaled with smooth surfaces. By way of example, it would be possible for the drag and drop zone of slide controls (cf. FIG. 13) to be configured with a smooth surface. FIG. 13 shows two slide controls on a medium 1 having operator control elements 7 and interactive components on the input interface 3. The user alters the value for the slide control with the label “parameter B”.

FIGS. 14A-B show dynamic input on the medium. For the dynamic input, operator control elements 7 on the medium can be used as spacers for dynamic contents on the underlying touchscreen (=input interface 3). As shown in the figures, the medium contains numerals as operator control elements 7 that prescribe to the user (=input means 5) an order in which the operator control elements 7 or the touch areas 2 need to be touched. This can be used for example to request passwords with a prescribed numerical sequence on the medium (FIG. 14B, left) and a dynamic numerical sequence on the input interface (FIG. 14B, right).

FIG. 15 shows a further variant embodiment of the layout of operator control elements 7 on the medium 3 and dynamic contents on the interface 1, e.g. a screen. The dynamic contents are always displayed at the same position in relation to the operator control elements 7. This can be used to change the menu components, for example. When the same medium is laid on, menus A-E are displayed on certain days of the week and menus A-C are displayed on other day of the week.

FIG. 16 shows the use of the medium as an operator control aid. The medium 1 can have operator control elements 7 that are provided with a Braille relief embossment and can therefore be used as pointers for visually impaired people so that they are also able to make inputs on input interfaces 3.

### LIST OF REFERENCE SYMBOLS

1 Electrically nonconductive medium
2 Touch areas
3 Input interface
4 Electrical appliance
5 Input means
6 Positioning means
7 Operator control element

1. A system for triggering at least one touch event on a device having a capacitive and/or resistive input interface, wherein the system comprises at least one layer of an electrically nonconductive medium, the medium has touch areas present on it in the form of geometrical shapes and the medium is in contact with the input interface, the medium being a material selected from the group comprising plastic, paper, card, glass, textiles or a combination of these.

2. The system as claimed in claim 1, wherein a piece of information pertaining to the operator control of the touch areas is present on the medium and/or the appliance.

3. The system as claimed in claim 1 or 2, wherein the geometrical shapes and/or lines are realized additively or subtractively.

4. The system as claimed in one or more of the preceding claims, wherein the electrically nonconductive medium additionally has regions of electrically conductive regions present on it.

5. The system as claimed in one or more of the preceding claims, wherein a plurality of layers of an electrically nonconductive medium are in contact with the input interface in combination, particularly next to one another and/or above one another.

6. The system as claimed in one or more of the preceding claims, wherein the medium and/or the input interface has operator control elements.

7. The system as claimed in one or more of the preceding claims, wherein at least one positioning means is present on or in the medium.

8. The system as claimed in one or more of the preceding claims, wherein the medium has haptic, visual or tactile operator control elements selected from the group comprising
a. Change in a surface structure of the material of the medium
b. Relief and/or embossment on the medium
c. Different materials
d. Printed regions
e. Cutouts
f. Punchings from the medium and/or
g. Perforations.

9. The system as claimed in one or more of the preceding claims, wherein the operator control elements, positioning means and/or the touch areas have at least one layer of an electrically conductive material.

10. A method for triggering at least one touch event on an input interface comprising the following steps:
a. at least one layer of an electrically nonconductive medium is brought into contace with a touch-sensitive area of an input interface,
b. at least one geometrical shape that is present on the layer is touched using an electrically conductive or nonconductive means, and
c. at least one touch event is triggered on the input interface.

11. A method for triggering at least one touch event on an input interface comprising the following steps:
a. A layer of the medium as claimed in one or more of claims 1 to 9 is brought into contact with a touch-sensitive area of an input interface,
b. at least one touch event is triggered on the input interface by means of the conductive regions,
c. the conductive regions of the medium are recognized,
d. the operator control elements are aligned on the touch-sensitive area of the input interface,
e. the functionalities of the operator control elements are activated,
f. at least one further touch event is triggered by a user on the touch-sensitive area of the input interface.

12. The method as claimed in claim 10 or 11 for triggering an action and/or an event on an electrical appliance that has an input interface.

13. The method as claimed in one or more of the preceding claims, wherein the touch(es) is/are effected statically, dynamically, once, repeatedly, simultaneously and/or in a manner staggered over time.

14. The method as claimed in one or more of the preceding claims, wherein the touch areas to be touched and an order for the touch are indicated by the input interface and/or the medium.

15. The use of a system as claimed in claims 1 to 9 for triggering an action and/or an event on an electrical appliance that has an input interface.

16. The use as claimed in claim 15, wherein the medium and/or appliance indicates the regions to be touched and the order/type/gesture of the touch.
